(19) United States
(12) Patent Application Publication
(10) Pub. No.: US 2005/0168307 A1
(43) Pub. Date: Aug. 4, 2005

(54) High output magnetic inertial force generator

(76) Inventors: Michael G. Reynolds, Troy, MI (US); William C. Goodwin, Brighton, MI (US)

Correspondence Address: LESLIE C. HODGES;General Motors Corporation, Mail Code 482-C23--B21, P.O. Box 300, Detroit, MI, 48265-3000, US

(21) Appl. No.: 10/772,008

(22) Filed: Feb. 4, 2004

(51) Int. Cl. H01F 7/08

(52) U.S. Cl. 335/220

(57) ABSTRACT

A magnetic force generator includes a magnetic shell internally defining an armature chamber. At least three circumferential electric coils are spaced axially within the chamber. An armature supported in the chamber for reciprocation therein includes a plurality of aligned magnets separated by at least one intermediate magnetic steel plate sandwiched between like poles of adjoining magnets and a pair of end steel magnetic plates on opposite ends of the armature. The plates extend laterally to a periphery of the armature in general lateral alignment with the electric coils. Springs nominally center the armature between non-magnetic ends of the chamber. Controlled energizing of the coils reciprocates the armature axially relative to the shell to develop an opposite inertia force on the shell for application to a connected body. The use of multiple magnets improves performance and/or reduces cost compared to a single magnet of comparable size.

### TECHNICAL FIELD

This invention relates to magnetic inertial force generators, and, more particularly, to an improved generator capable of higher output and/or manufacturable at lower cost.

### BACKGROUND OF THE INVENTION

FIG. 1 illustrates a known form of magnetic inertial force generator 60, including a cylindrical housing 62 defining internally an armature chamber 64 containing an armature 66 reciprocable along a central axis 68. The housing 62 is formed with a cylindrical magnetic steel shell 70 closed by aluminum end caps 71, 72 and containing a pair of axially spaced electric coils 73, 74 mounted on the interior of the housing 62.

The armature 66 includes a permanent magnet 76 having axially spaced north N and south S poles at opposite ends on which a pair of magnetic steel end plates 78 are mounted. The end plates 78 extend laterally to outer ends 80, forming a periphery of the armature 66 in general alignment with the electric coils 73, 74. The permanent magnet 76 generates a magnetic flux field concentrated in the steel end plates 78 and extending radially through the coils 73, 74 into the steel shell 70. Resilient springs 82 between the end plates 78 and the end caps 71, 72 of the housing 62 are configured for nominally centering the armature 66 between the end caps within the chamber 64.

In operation, alternating frequency charging of the coils generates electromagnetic forces that act on the permanent magnetic flux field to cause relative reciprocating motion between the armature 66 and the surrounding housing 62. The reciprocating motion causes the inertia of the armature 66 to apply a reactive inertia force on the housing 62, which is capable of being exerted on a connected body for any desired purpose. Such purposes may include for example, vibration testing of manufactured assembles, and reduction or cancellation of vibrations by application of forces opposite to the forces stimulating the motion of the vibration.

### SUMMARY OF THE INVENTION

The present invention provides an improved magnetic force generator which is capable of providing increased inertia force in a package of the same size and/or of providing comparable output at a lower cost for manufacture of a force generator.

The force generator is improved by substituting a plurality of two or more permanent magnets in place of the single magnet of the prior art design. Between each of the separate magnets an intermediate steel plate is sandwiched which is contacted by like poles of the adjacent magnets. A pair of steel magnetic end plates are located at the magnetic ends of the armature as in the previous embodiment.

Separate plates of the armature all extend laterally to a periphery thereof and are located in general alignment with electric coils provided the inner surface of the surrounding housing. The housing is preferably cylindrical, but could be of any desired cross-sectional configuration. The surrounding housing may be made of magnetic steel as before and provided with aluminum end caps and springs centering the armature between the end plates. Evaluation indicates that use of multiple aligned magnets in the armature provides a greater output from an armature having the same length and can be manufactured at a lesser cost because the amount of magnetic material is reduced by addition of the intermediate plates sandwiched between the magnet sections.

These and other features and advantages of the invention will be more fully understood from the following description of certain specific embodiments of the invention taken together with the accompanying drawings.

### BRIEF DESCRIPTION OF THE DRAWINGS

FIG. 1 is a cross-sectional view of a prior art magnetic force generator; and

FIG. 2 is a cross-sectional view similar to FIG. 1 but showing an improved magnetic force generator in accordance for the invention.

### DESCRIPTION OF THE PREFERRED EMBODIMENT

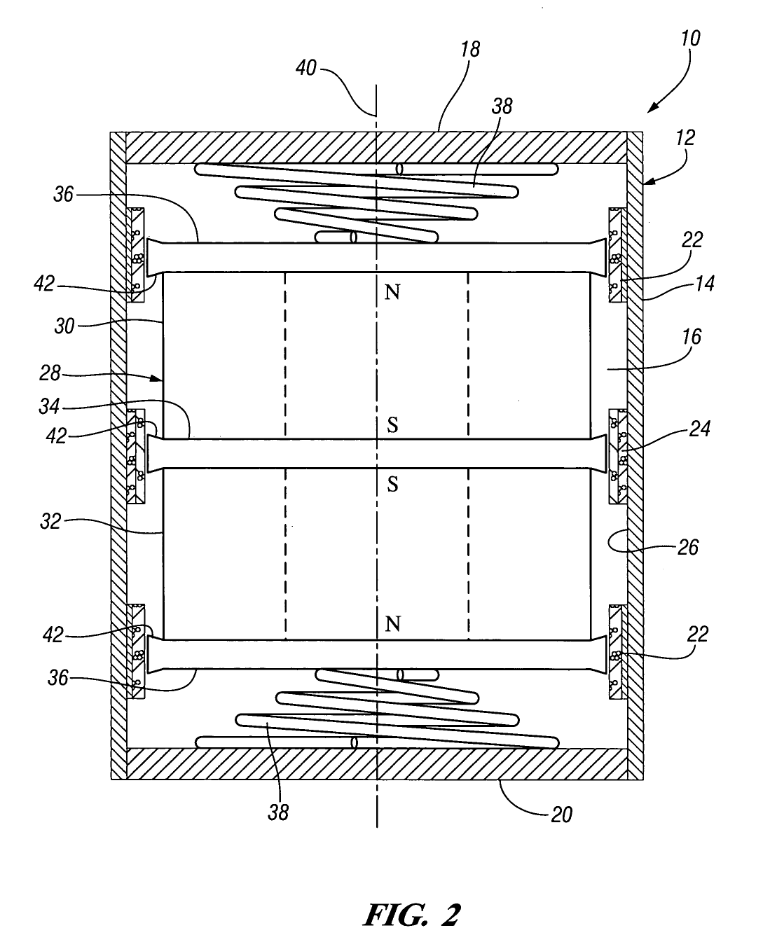

Referring now to FIG. 2 of the drawings in detail, numeral 10 generally indicates a magnetic force generator formed in accordance with the invention. Force generator 10 includes a housing 12 having a generally cylindrical outer shell 14 defining an inner cylindrical chamber 16 closed at its ends by nonmagnetic aluminum end caps 18, 20. A plurality of at least three circumferential electric coils, including end coils 22 and intermediate coil 24, are spaced longitudinally within the chamber 16 and mounted on the cylindrical inner surface 26 of the outer shell 14. The end coils 22 each comprise a single coil row, while the intermediate coil 24 comprises two concentric coil rows, although this arrangement is not required for the practice of the invention.

Within the chamber 16 an armature 28 is reciprocably supported. Armature 28 includes a plurality of at least two axially aligned permanent magnets 30, 32 separated by an intermediate magnetic steel plate 34 which is connected between like poles of the two magnets 30, 32, for example the south poles S. Magnets 30, 32 may be ring magnets as shown or may be formed with any desired configuration. Ring magnets are preferred because the cavity inside the magnet provides a convenient location to add weight to aid in adjusting the resonant frequency of the actuator. However, cylindrical magnets may also be used.

At the opposite ends of the armature 28, magnetic steel end plates 36 are fixed to the north pole N ends of the magnet 30, 32. As assembled, the magnets 30, 32 of the magnetic force generator 10 develop dual magnetic flux fields (in the case of dual magnets) which pass, for example, from the north poles of the magnets through the end plates 36 to the magnetic outer shell 14 and then toward the center into the intermediate steel plate 30.

The armature 28 is centered in the chamber 16 by a pair of compression springs 38. Springs 38 are fixed to the end plates 36 and engage the end caps 18 to bias the armature toward the center of the chamber 16. The arrangement allows the armature to move reciprocably against the springs 38 along the central axis 40 but restrains the armature against lateral motion within the chamber 16. When the armature is centered, the outer ends 42 of the intermediate and end steel plates 34, 36 are positioned opposite from and in general longitudinal alignment with the intermediate and end coils 24, 22 mounted within the housing 12.

In order to provide the desired operation of the force generator, the end coils 22 are preferably wound in a first direction and the intermediate coil 24 is preferably wound in an opposite direction for connection of the coils to a controllable frequency alternating current (AC) voltage. It should be understood, however, that other ways of winding the coils and connecting the coils to the AC voltage may be utilized if desired. Also, it should be understood that more than two individual permanent magnets may be aligned in series to form the armature 28, in which case the arrangement in the poles of the magnet would be adjusted accordingly.

In operation, an AC voltage of controllable frequency is applied to the end and intermediate coils 22, 24 so that all of the coils exert forces on their associated steel plates 34, 36 in the same direction at the same time. Because the current is alternating, the forces naturally vary in direction twice each cycle of the alternating current and so tend to oscillate the armature along the axis 40 within the housing 12. The inertia of the armature 28 resists the movement of the armature and thus provides equal and opposite forces on the housing mounted coils which tend to move the housing 12 in a direction along axis 40 opposite to the direction in which the armature is being urged to move.

The alternating forces generated between the armature 28 and the coils 22, 24, thus apply reciprocating forces against the housing 12 which may be transferred to any body, not shown, to which the housing is connected or on which it is mounted. Thus, for example, the housing 12 may be mounted to a plate on which parts are mounted for vibration testing. In another example, the housing may be mounted to an engine component which is stimulated by vibration forces generated by the moving components of the engine during operation.

By means of suitable sensors and control means known in the art, the alternating voltage applied to the coils 22, 24 may be timed to generate opposite reciprocating forces in the housing that are timed to offset the vibrations of the engine component to which the force generator may be attached. In this way, the reciprocating motion of the housing applies the developed inertia force against the vibration motion of the engine to which the housing is attached and thus wholly or partially offsets the vibration of the engine and causes it to be perceived as operating in a smooth and nonvibrational manner.

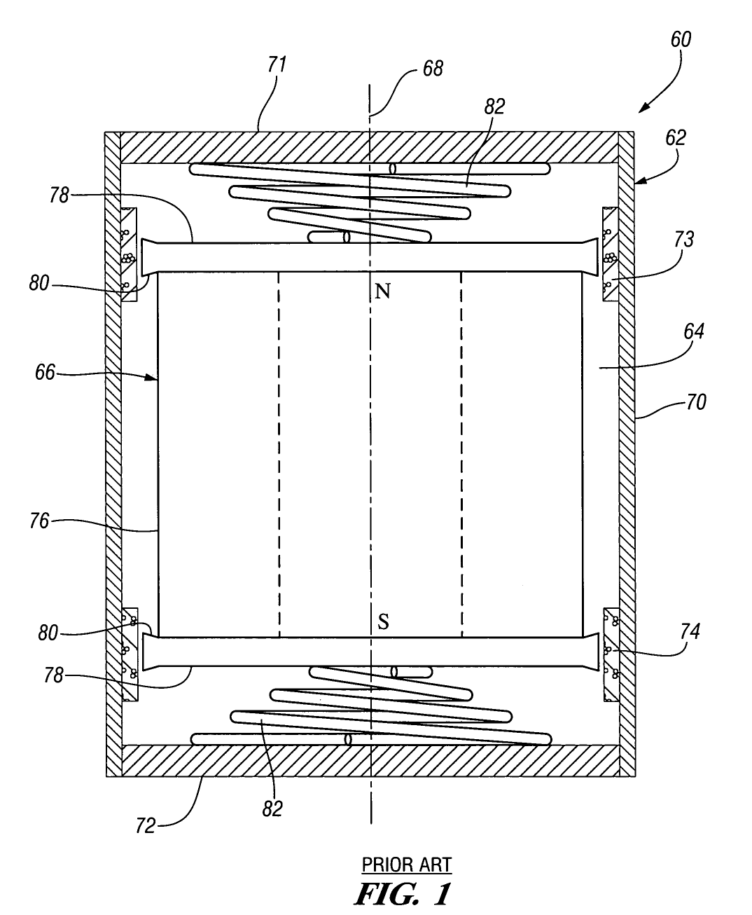

The arrangement of the coils 22, 24 and the use of dual magnets in the embodiment of FIG. 2 represents only one possible example of improved magnetic force generator in accordance with the invention. The arrangement was developed for comparison of the new device with the prior art device of FIG. 1, where the sizes of the devices are the same and the same total number of turns of the coils are utilized. The amount of magnet material in the new design is reduced by addition of the center pole, which reduces the cost of the magnet material. Sizes of the three plates are the same in this embodiment.

Evaluation of closely similar devices showed that the dual magnet force generator of FIG. 2 has a 31 percent higher force constant (Newtons per Ampere) than the single magnet force generator of the prior art FIG. 1. Also, the dual magnet design of FIG. 2 contains about 8 percent less magnet material, resulting in a cost reduction.

These results indicate that additional performance and cost improvements may be available from additional variations, such as an increased number of shorter magnets separated by additional plates and the provision of additional coils in the housing. Other variations affecting the mass of the devices and the effective power of the coils may of course also be useful.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A magnetic force generator comprising:
a magnetic shell internally defining an armature chamber having an axis;
at least three circumferential electric coils spaced axially within the chamber;
an armature supported in the chamber for reciprocation on the axis, the armature including a plurality of aligned magnets separated by at least one intermediate magnetic steel plate sandwiched between like poles of adjoining magnets and a pair of end steel magnetic plates on opposite ends of the armature, the plates extending laterally to a periphery of the armature in general lateral alignment with the electric coils; and
resilient members nominally centering the armature between non-magnetic ends of the chamber;
controlled energizing of the coils being operative on the magnetic plates to reciprocate the armature axially in a controlled manner relative to the shell to develop an opposite inertia force on the shell for application to a connected body.

2. A magnetic force generator as in claim 1 wherein the resilient members are compression springs.

3. A magnetic force generator as in claim 1 wherein the number of aligned magnets is two.

4. A magnetic force generator as in claim 1 wherein the aligned magnets are ring magnets.

5. A magnetic force generator as in claim 1 wherein the number of the intermediate and end steel magnetic plates in the armature is equal to the number of the circumferential electric coils spaced within the shell.

6. A magnetic force generator as in claim 1 wherein the magnetic shell is part of a housing including non-magnetic end members closing the ends of the chamber.

7. A magnetic force generator comprising:
a magnetic shell internally defining an armature chamber having an axis;
at least three circumferential electric coils spaced axially within the chamber;
an armature supported in the chamber for reciprocation on the axis, the armature including a plurality of aligned magnets separated by at least one intermediate magnetic steel plate sandwiched between like poles of adjoining magnets and a pair of end steel magnetic plates on opposite ends of the armature, the plates extending laterally to a periphery of the armature in general lateral alignment with the electric coils; and
resilient members nominally centering the armature between ends of the chamber;
controlled energizing of the coils being operative on the magnetic plates to reciprocate the armature axially in a controlled manner relative to the shell to develop an opposite inertia force on the shell for application to a connected body.
